(19) United States
(12) Patent Application Publication
(10) Pub. No.: US 2026/0150156 A1
(43) Pub. Date: May 28, 2026

(54) Electric Heating Device and Method for its Producing

(71) Applicant: Eberspächer catern GmbH & Co., Herxheim (DE)

(72) Inventors: Timo Kröner, Rülzheim (DE); Simon Stuppert, Berg (DE); Müge Pilavtepe-Christ, Karlsruhe (DE); Patrick Werner, Neuhofen (DE)

(21) Appl. No.: 19/400,114

(22) Filed: Nov. 25, 2025

(30) Foreign Application Priority Data
Nov. 28, 2024 (DE) 102024135151.9

(51) Int. Cl. H05B 3/02

(52) U.S. Cl. CPC H05B 3/02

(57) ABSTRACT

An electric heating device has an at least partially electrically conductive housing and a cover that is formed from sheet metal and that closes the housing. A circumferential groove is provided on an end face of the housing. An adhesive is introduced into the groove, and the cover has a circumferential edge which engages in the groove in such a way that the circumferential edge of the cover is immersed circumferentially in the adhesive. The sealing and fastening of the cover relative to the housing is improved by the fact that circumferential the edge is in contact with a surface that laterally limits the groove and that is arranged at a distance from the opposite surface of the groove.

### BACKGROUND OF THE INVENTION

### 1. Field of the Invention

The present invention relates to an electric heating device, in particular for a motor vehicle, with an at least partially electrically conductive housing, on the front side of which a circumferential groove is provided, and a cover formed from sheet metal which closes the housing, wherein an adhesive is introduced into the groove and the cover has a circumferential edge which engages in the groove in such a way that the edge of the cover is immersed circumferentially in the adhesive.

### 2. Background of the Invention

An electrical heating device known from DE 10 2022 127 107 A1 and its U.S. counterpart 20240125514A1, the subject matter of which is incorporated herein in its entirety, is considered to be generic. This prior art discloses an electrical heating device with an at least partially electrically conductive housing and a cover formed from sheet metal, which closes the housing. The cover has a covering surface covering the housing, from which the surrounding edge basically extends at right angles. The groove formed by the housing has projections on opposite surfaces delimiting the groove. These are wave-shaped and arranged alternately to each other so that wave corrugation crests on one side are opposite wave corrugation valleys on the other side. This improves the connection between the cover and the housing. In particular, it ensures a secure metallic contact between the cover and the housing.

An electrical heating device with a housing forming a groove, which is filled with an adhesive and into which a rim formed by a cover is immersed, is also known from DE 10 2022 110 017 A1 and US 20240125514 A1. In this solution, the rim is clamped in sections between projections protruding from both sides of the groove.

The present invention relates in particular to an electric heating device in which the housing has a circulation chamber with inlet and outlet openings for a fluid to be heated, a heating device connected to the circulation chamber in a thermally conductive manner, a connection chamber in which the heating device is electrically connected, and a partition wall, wherein the partition wall separates the circulation chamber from the connection chamber in a fluid-tight manner. The heating device can be a PTC heating device with a PTC element for heating a medium in the circulation chamber. Alternatively, the heating device can also be a thick-film heating device.

In the electrical heating device according to the invention, for example, several PTC heating devices are accommodated in the housing. Thus, several PTC heating devices are usually electrically connected in the connection chamber, possibly also grouped into heating circuits. For this purpose, a printed circuit board may be provided in the connection chamber, which assigns different PTC heating devices to different heating circuits. The connection chamber may also contain an assembled printed circuit board, which is a central component of a control device that is typically used to control the multiple PTC heating devices in order to set the appropriate power output of the electric heating device.

These details are known from DE 20 2020 000 689 U1.

The above-mentioned features may also be preferred features of the electrical heating device according to the invention.

With corresponding electrical heating devices, there is a problem of interference with other components in the vicinity due to electromagnetic waves, particularly when switching the heating device. In a vehicle, for example, these components may include electronic components or components of the on-board entertainment system. In view of this, it is known to design the housing to be at least partially electrically conductive for the purpose of shielding. In particular, the connection chamber and the control device provided therein are housed in a metallic housing. Parts of the housing surrounding or defining the circulation chamber may be made of an electrically non-conductive material. Plastic is preferred in order to reduce weight.

The requirements for an electric heating device in a motor vehicle in particular impose various additional requirements. For example, the electric heating device must not only be designed to be as lightweight as possible. Rather, the electrical components of the electric heating device should be reliably protected from the environment. This applies in particular to electric heating devices for electric mobility. These electric heating devices are usually operated at high voltage. Moisture and/or contamination that penetrates the connection chamber, for example, can impair the desired electrical insulation of individual components. Contaminated or moistened surfaces can promote the formation of leakage currents.

### SUMMARY OF THE INVENTION

The present invention is based on the problem of specifying an electric heating device that enables the best possible sealing of the housing while reliably shielding the electrical components housed therein. The proposal must be capable of being implemented in a process-reliable manner.

To solve this problem, the present invention provides an electric heating device of the type mentioned at the beginning, in which the edge is in contact with a surface bordering the groove on the side and is arranged at a distance from an opposite surface of the groove.

A circumferential groove in this sense is understood to be a groove that is formed circumferentially in the direction of the groove. It is not important that the groove is formed with the same depth over the entire circumference. An adhesive is applied to the groove. This adhesive seals the cover. For this purpose, the cover has a circumferential edge that engages in the groove in such a way that the edge of the cover is immersed in the adhesive around its entire circumference. This results in a fully fluid-tight sealing of the cover in the area of the groove. An adhesive that hardens but remains elastic in its hardened state is particularly suitable for this purpose. For example, a silicone adhesive can be used.

The adhesive not only serves to hold the lid in place. The adhesive also acts as a sealing compound that prevents the passage of dirt and/or moisture in the area of the groove by engaging the surrounding edge in the adhesive.

Compared to the solution known from DE 10 2022 127 107 A1 and US 20240125514 A1, a certain distance remains between the opposing surfaces, which may be formed by the outer surface of the groove, between the groove, possibly the outer surface of the groove, and the edge over the entire length of the groove, which is usually filled with adhesive and thus ensures a secure seal of the cover in the groove. The gap usually results in a groove filled with adhesive running around the circumference between the opposite surface and the edge. It is understood that adhesive will also be provided below the edge, i.e., between the bottom of the groove and the front end of the edge. The opposite surface may be in y straight in sections. Only the basic alignment of the groove-deflecting corners of the housing form areas in which the opposite surface is not straight.

The cover may be made of a sheet metal cover. This wording conveys that the material of the cover has a wall thickness predetermined by the raw material of the sheet metal. The cover may be formed by punching and bending or other forming processes in such a way that a circumferential edge protrudes essentially at right angles from the otherwise basically flat covering surface of the cover. The cover accordingly forms a covering surface which is regularly bounded on the outside by the edge.

Since the edge is in contact with the surface delimiting the groove on one side, this contact results in an electrical connection and thus reliable EMC protection. As is known from DE 10 2022 127 107 A1 and US 20240125514 A1, the surface in contact with the edge can be wave-shaped so that corrugation crests may abut the edge, deforming it, and corrugation valleys are provided between them, leaving a space between themselves and the surface laterally bounding the groove. This surface delimiting the groove laterally is usually surrounded by the edge. This may form the inner surface of the groove, which is provided for the interior of the housing.

The corrugation valleys can additionally be filled with adhesive, which improves the material bond of the edge within the groove and the seal.

The corrugation crests may cause plastic deformation of the edge to increase strength and/or secure electrical contact.

The present invention proposes further measures to make the manufacturing process more reliable. In the manufacturing process, the adhesive may be dosed volumetrically into the groove in such a way that the adhesive reliably covers the edge when it is subsequently immersed in the groove, thereby securing it in place. The edge is then inserted into the groove and immersed in the adhesive bath. The adhesive is displaced in the direction of the groove opening and thus in the vertical direction. By adjusting the height of the edges bordering the groove, it is possible to prevent the adhesive displaced upwards from entering the housing. Thus, the inner edge preferably has a greater height than the outer edge. Any adhesive displaced beyond the groove will flow over the outer edge and outwards, thus preventing it from entering the housing. In addition, the inner edge can form a contact area that acts as a stop surface for the cover when the edge is inserted into the groove, thus limiting the depth to which the edge penetrates into the groove. Preferably, the cover rests against this contact area abutting it after joining.

### BRIEF DESCRIPTION OF THE DRAWINGS

Further details and advantages of the present invention are apparent from the following description of an embodiment in conjunction with the drawing. This shows:

FIG. 1 a perspective exploded view of an embodiment of an electric heating device;

FIG. 2 a longitudinal sectional view of a PTC heating element of the heating device according to FIG. 1;

FIG. 3 a perspective side view of a schematically represented housing with a cover;

FIG. 4 a longitudinal sectional view through the groove and the edge of the cover for the example according to FIG. 3; and

FIG. 5 a cross-sectional view through the groove and the edge of the cover for the example according to FIG. 3.

### DETAILED DESCRIPTION

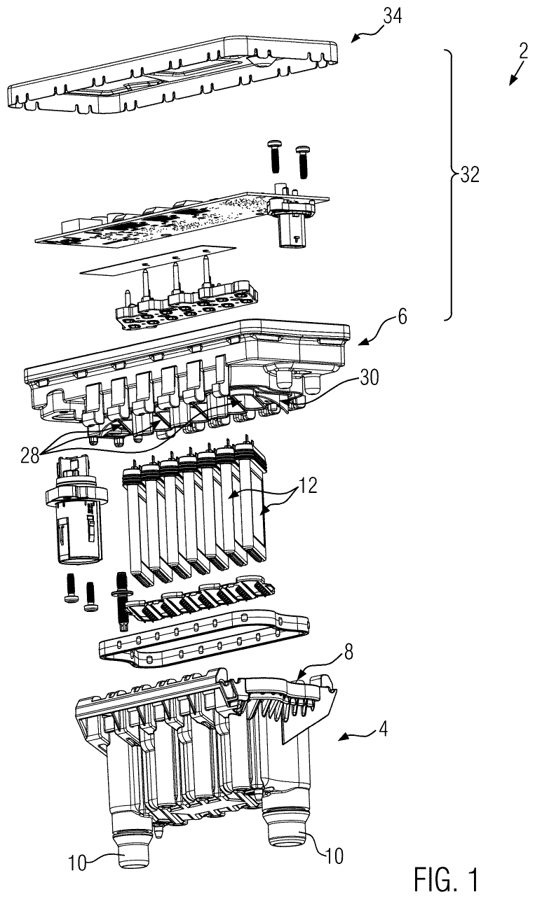

FIG. 1 shows an embodiment of an electric heating device 2 with a multi-part heater housing, which comprises a housing lower part 4 formed from plastic and a housing upper part 6 formed from metal in one piece by die casting.

The housing lower part 4 is trough-shaped and encloses a heating chamber 8 and forms inlet and outlet connections 10 that communicate with the heating chamber 8. These inlet and outlet connections 10 are formed integrally with the housing lower part 4 by means of injection molding. Several heating devices 12 are shown between the upper part of the housing 6 and the lower part of the housing 4.

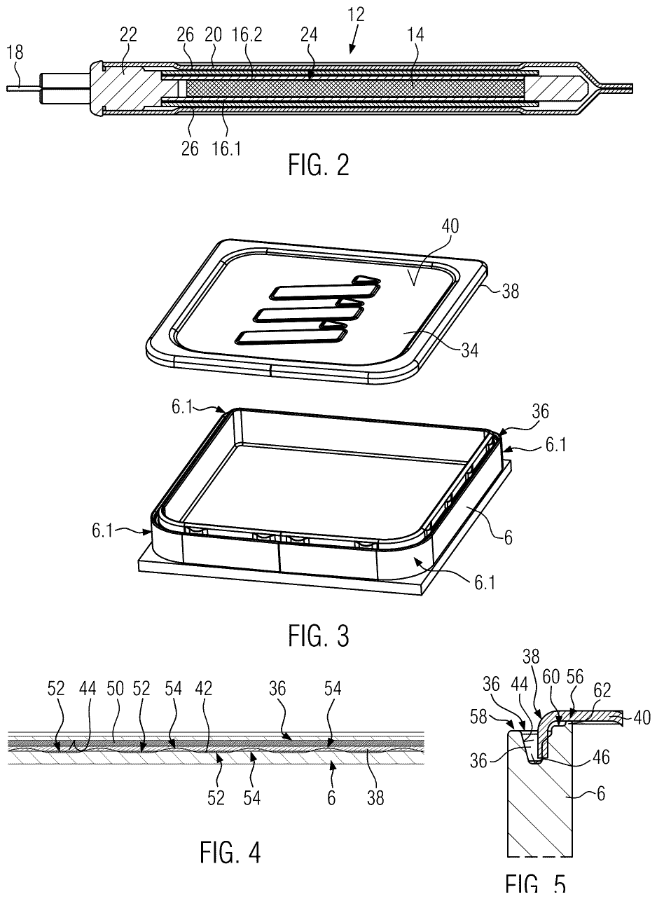

As FIG. 2 illustrates, these heating devices 12 each have at least one PTC element 14, to which contact elements 16.1; 16.2 abut, which form contact tongues 18 that protrude from a metal housing 20. The PTC element 14 is housed in a frame 22 and between the contact elements 16.1; 16.2. Insulating layers 26 are provided between the metallic housing 20 and a heating cell 24 formed by the two contact elements 16.1; 16.2 and the PTC element 14.

The heating devices 12 are held in a plug-in contact manner in a receptacle 28 provided for this purpose in a partition wall 30 of the upper part 6 of the housing and are electrically connected and controlled in a connection chamber 29 of a control device 32. Details of this design are described in EP 3 334 242 A1, which is based on the applicant's application.

In FIGS. 1 and 3, reference numeral 34 denotes a cover which is connected to the upper part of the housing 6 in a sealing and electrically conductive manner. This component, also referred to as housing 6 in the following, is shown in FIG. 3 in a perspective side view. It can be seen that the housing 6 has a circumferential groove 36, the course of which corresponds to the geometry of a circumferential edge or rim 38 of the cover 34, which protrudes from a cover surface 40 formed by the cover 34. The design of the groove 36 is shown in particular in FIGS. 4 and 5.

Reference numeral 42 denotes a surface of the groove that delimits the groove 36 laterally toward the outside. Reference numeral 44 denotes the opposite inner surface of the groove 36 on its inner side. These two surfaces, which are also referred to as the inner surface 42 and the outer surface 44, extend from a groove base 46. As FIG. 4 illustrates, the outer surface 44 runs in a straight line and at a distance from the edge 38. The straight line of the outer surface 44 is only interrupted at the corners 6.1 of the housing 6, which is rectangular in plan view.

This results in a constant film of adhesive 50 between the edge 38 and the outer surface 44. As FIG. 4 further illustrates, the inner surface 42 is wavy. It has wave troughs 52 and corrugation crests 54. The corrugation crests 54 are in direct contact with the edge 38. When the edge is inserted into the groove 36, the adhesive 50 is scraped off by the corrugation crests 54. The corrugation crests 54 plastically deform the edge 38 in sections, thereby creating increased strength of the mechanical connection between the cover 34 and the housing 6. As FIG. 4 further shows, the adhesive 50 is also located in the corrugation valleys 52. Since the surface sections contacting the edge 38 are formed by the inner surface 42, this inner surface is clamped circumferentially by the edge 38, further improving the strength.

Further details of the groove 36 are discussed below with reference to FIG. 5, whereby the height of the groove 36 in the sense of the present description is to be understood as the extension of the groove 36 upward from the groove base 46 to the open end of the groove 36. An inner edge marked with reference numeral 56 in FIG. 5 is higher overall than an outer edge 58 from which the outer surface 44 extends. The inner edge 56 has an intermediate area 60 and a contact area 62 offset inwardly therefrom, which in the present case is provided in the form of a circumferential web.

Since the outer edge 58 is offset downwards relative to the inner edge 56, any excess adhesive that is displaced when the edge 38 is inserted into the groove 36 is carried away to the outside. This makes the bonding of the cover 34 more reliable. There is no risk of the adhesive 50 entering the interior of the housing 6, which is closed by the cover 34.

1. An electric heating device comprising:
an at least partially electrically conductive housing, on a front side of which a circumferential groove is provided; and
a cover that is formed from sheet metal and that closes the housing,
wherein an adhesive is applied to the groove, and the cover has a circumferential edge that engages in the groove in such a way that the circumferential edge of the cover is immersed circumferentially in the adhesive, and
wherein the circumferential edge is in contact with a surface that laterally delimits the groove and that is arranged over an entire length of the groove in a circumferential direction of the groove at a distance from an opposite surface of the groove.

2. The electric heating device according to claim 1, wherein the surface that is contacted by the circumferential edge is corrugated, forming corrugation valleys and corrugation crests, wherein the corrugation valleys leave a space between themselves and the circumferential edge, and wherein the corrugation crests abut directly against the circumferential edge.

3. The electric heating device according to claim 2, wherein the corrugation valleys are filled with adhesive.

4. The electric heating device according to claim 2, wherein the opposite surface of the groove is formed to run in a straight line between corners that deflect a longitudinal direction of the groove.

5. The electric heating device according to claim 2, wherein the circumferential edge is plastically deformed by the corrugation crests.

6. The electric heating device according to claim 1, wherein a surface of the groove interacting with the circumferential edge is the inner surface of the groove lying within the circumferential edge.

7. The electrical heating device according to claim 6, wherein the outer surface provided opposite the inner surface of the groove is spaced apart from the circumferential edge over its entire circumference.

8. The electrical heating device according to claim 1, wherein an inner edge of the groove, which delimits the groove on an inside thereof, has a greater height than the opposite outer edge of the groove.

9. The electrical heating device according to claim 8, wherein the inner edge of the groove forms a contact area contacting a cover surface of the cover, and wherein an intermediate area is provided between the contact area and the groove and is offset relative thereto in a height direction toward a groove base.

10. The electrical heating device according to claim 9, wherein the intermediate area has a greater height than the outer edge.

11. The electrical heating device according to claim 1, wherein the electrical heating device is configured for use with a motor vehicle.

12. A method comprising:
providing an electrical heating device having an electrically conductive housing and a cover that is made of sheet metal, the housing having a circumferential groove on a front side thereof, and the cover having a circumferential edge;
applying adhesive to the groove; and
inserting the circumferential edge of the cover in the groove in such a way that the circumferential edge of the cover is immersed circumferentially in the adhesive, wherein
following the inserting, the circumferential edge is in contact with a surface that laterally delimits the groove and that is arranged over an entire length of the groove in a circumferential direction of the groove at a distance from an opposite surface of the groove.

13. The method according to claim 12, wherein the applying comprises volumetrically dosing the adhesive into the groove in such a way that the adhesive reliably covers the circumferential edge when the circumferential edge is subsequently immersed in the groove.

14. The method according to claim 13, wherein, during the inserting, the adhesive is displaced vertically a direction of a groove opening in such a manner as to prevent adhesive from entering the housing.

15. The method according to claim 14, wherein the groove is laterally delimited by inner and outer surfaces, the inner surface having a height that is greater than a height of the outer surface, and wherein any adhesive displaced vertically beyond the groove will flow over the outer surface and outwards.

16. The message according to claim 12, wherein the surface that laterally delimits the groove is corrugated, forming corrugation valleys and corrugation crests, wherein the corrugation valleys leave a space between themselves and the circumferential edge, wherein the corrugation crests abut directly against the circumferential edge after the circumferential edge after is inserted into the groove, and wherein the corrugation valleys are filled with adhesive after the inserting.
